(19) United States
(12) Patent Application Publication
(10) Pub. No.: US 2023/0347432 A1
(43) Pub. Date: Nov. 2, 2023

(54) VARIABLE CONDUCTIVITY ELECTRODE FOR PULSED ELECTROCHEMICAL MACHINING

(71) Applicant: Rolls-Royce Corporation, Indianapolis, IN (US)

(72) Inventors: Rusty M. Garner, Indianapolis, IN (US); Damon Ward, Indianapolis, IN (US); Monica Sy Munoz, Indianapolis, IN (US)

(21) Appl. No.: 17/661,447

(22) Filed: Apr. 29, 2022

(51) Int. Cl. B23H 3/06

(52) U.S. Cl. CPC B23H 3/06; B23H 2300/10

(57) ABSTRACT

The disclosure describes a pulsed electrochemical machining (pECM) tool that includes a tool body defining a tool axis and including one or more electrodes. Each of the one or more electrodes includes an electrically conductive material and defines a working surface at a distal end of the tool axis configured to face a workpiece. An electrical conductivity of at least one electrode varies across the working surface of the respective electrode.

### TECHNICAL FIELD

The disclosure relates to pulsed electrochemical machining (pECM).

### BACKGROUND

Machining processes may involve removal of material from a workpiece to form a component having a finished shape and texture. Pulsed electrochemical machining (pECM) is a non-contact machining process based on the principles of electrolysis. Pulsed electrochemical machining may also be referred to as precision electrochemical machining or pulse electrochemical machining. A pECM system may include a tool (the cathode) that imparts its shape into a workpiece (the anode) in a mirror image. As the tool moves toward a surface of the workpiece to be machined, a pulsed DC current may be applied to the tool and the workpiece. The tool maintains a tiny interelectrode gap (e.g., of less than about 10 microns) from the surface of the workpiece, and the workpiece dissolves anodically about the tool, taking on the complementary shape of the tool. An electrolyte pumped between the tool and the workpiece may remove dissolved metal from the workpiece and heat.

Since the cathodic tool does not physically contact the anodic workpiece, pECM can produce burr-free three-dimensional shapes with little or no tool wear. pECM may be used to machine any conductive metal or alloy, and is particularly well suited for materials, such as superalloys, that are difficult to machine through conventional methods. Materials commonly machined with pECM include, for example, nickel, iron, and titanium-based alloys in a variety of formats such as cast (including single crystal), forged, additively manufactured, and powdered metallurgy.

### SUMMARY

The disclosure generally describes systems and techniques for generating an electric current density between a machining tool and a workpiece that varies spatially across a working surface of the machining tool, and techniques for creating such machining tools. A pECM tool includes one or more electrodes formed from conductive materials. Each electrode defines a working surface for generating an electric current in an electrolyte between the electrode and the workpiece to remove material from the workpiece. A portion of the respective electrode near or at the working surface has an electrical conductivity that varies across the working surface to generate a spatially varying electric potential and, correspondingly, the spatially varying electric current density. For example, the electrode may include a composition that varies across the working surface, such as by using different materials having different electrical conductivities, different densities of materials, and other compositional parameters that affect electrical conductivity at the working surface. The spatially varying electric current density may remove material from the workpiece at different rates, thereby creating different interelectrode gap sizes between the electrode and the workpiece. As a result, a contour or shape of a machined surface of the workpiece may be different from a contour or shape of a working surface of the electrode.

In some examples, the disclosure describes a pulsed electrochemical machining (pECM) tool that includes a tool body defining a tool axis and including one or more electrodes. Each of the one or more electrodes includes an electrically conductive material and defines a working surface at a distal end of the tool axis configured to face a workpiece. An electrical conductivity of at least one electrode varies across the working surface of the respective electrode.

In some examples, the disclosure describes a method for manufacturing a pulsed electrochemical machining (pECM) tool that includes forming one or more electrodes from an electrically conductive material. Each of the one or more electrodes defines a working surface of a distal end of a tool axis of a tool body. The working surface is configured to face a workpiece. An electrical conductivity of at least one electrode varies across the working surface of the respective electrode.

In some examples, the disclosure describes a method for pulsed electrochemical machining (pECM) a workpiece that includes generating an electric potential between one or more electrodes of a machining tool and the workpiece. The machining tool includes a tool body defining a tool axis and including the one or more electrodes. Each of the one or more electrodes includes an electrically conductive material and defines a working surface at a distal end of the tool axis configured to face the workpiece. The method includes delivering an electrolyte into an interelectrode gap between the working surface of the one or more electrodes and a target surface of the workpiece. The method includes positioning the working surface of the one or more electrodes relative to the target surface of the workpiece to remove material from the target surface of the workpiece.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating a pulsed electrochemical machining (pECM) system.

FIG. 1B is a side view cross-sectional conceptual diagram illustrating operation of a pECM tool of the pECM system of FIG. 1A.

FIG. 1C is a side view cross-sectional conceptual diagram illustrating a magnified view of a portion of FIG. 1B.

FIG. 1D is a conceptual block diagram illustrating an example control system of the pECM system of FIG. 1A.

FIG. 1E is a flow diagram illustrating an example technique for controlling the pECM system of FIG. 1A.

FIG. 2A is a side view cross-sectional conceptual diagram illustrating a pECM tool that includes two different discrete distal portions having different bulk electrical conductivities.

FIG. 2B is a side view cross-sectional conceptual diagram illustrating a pECM tool that includes two different discrete distal and lateral portions having different bulk electrical conductivities.

FIG. 3A is a side view cross-sectional conceptual diagram illustrating a pECM tool that includes a distal portion having one or more gradients of electrical conductivity.

FIG. 3B is a bottom view conceptual diagram illustrating the pECM tool of FIG. 3A.

FIG. 3C is an exemplary graph illustrating a relationship between a radial gradient of electrical conductivity of FIG. 3B and a volume ratio to two components having different electrical conductivities.

FIG. 3D is an exemplary graph illustrating a relationship between a radial gradient of electrical conductivity of FIG. 3B and a density and porosity of an electrically conductive material.

FIG. 4A is a flow diagram illustrating an example process for manufacturing a pECM tool that includes discrete portions of a working surface having different electrical conductivities.

FIG. 4B is a flow diagram illustrating an example process for manufacturing a pECM tool that includes a working surface having one or more gradients of electrical conductivity.

### DETAILED DESCRIPTION

The disclosure generally describes pECM systems and techniques that include one or more electrodes, which function as one or more cathodes during a pECM process, that have an electrical conductivity that varies spatially across a working surface of the electrode. During material removal via the pECM process, a contour and shape of a machined surface of a workpiece may correspond to a contour and shape of a working surface of the electrode and a current density flowing across an interelectrode gap between the electrode (cathode) and the workpiece (anode). The current density may be a function of a local electric potential between the electrode and the workpiece, which may influence a rate of material removal from the workpiece and a size of the interelectrode gap between the electrode and the workpiece. For example, a higher electric potential may correspond to a larger interelectrode gap.

In the present disclosure, one or more electrodes of the pECM machining tool may have an electrical conductivity that varies spatially across the working surface of the electrode. This spatially varying electrical conductivity may produce an interelectrode gap that varies spatially between the electrode and the workpiece. For example, portions of the working surface having a higher electrical conductivity may have an increased local current density, and corresponding increased thickness of the interelectrode gap near that portion of the working surface. As a result, the machined surface of the workpiece may reflect both a shape of the working surface of the electrode and the electric potential produced by the electrical conductivity of the working surface of the electrode. Additionally or alternatively, the machined surface may reflect a shape of the working surface of the electrode, the electric potential produced by the electrical conductivity of the working surface of the electrode, and an electrical conductivity of the electrolyte, such as an electric potential that compensates for a change in electrical conductivity of the electrolyte to maintain a relatively uniform interelectrode gap.

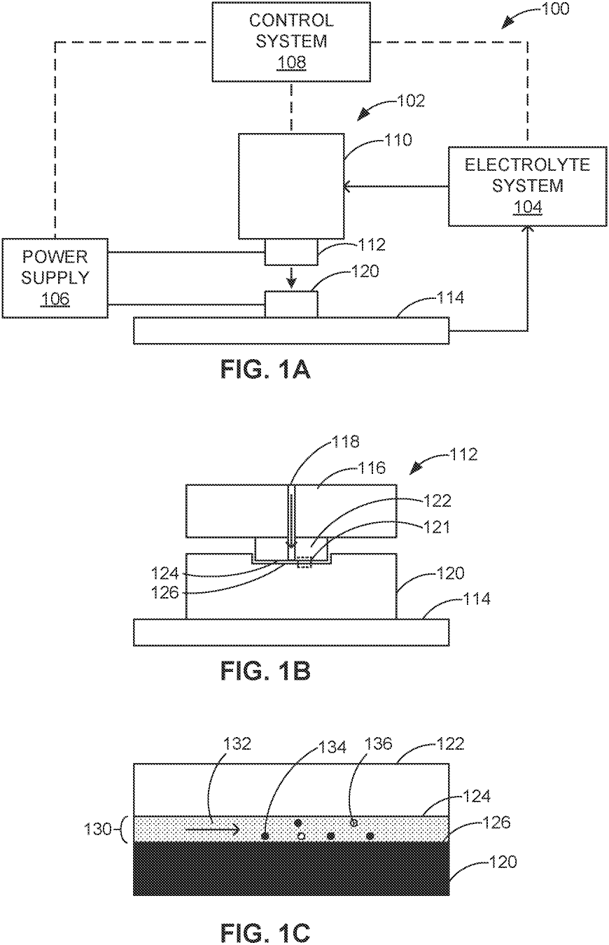

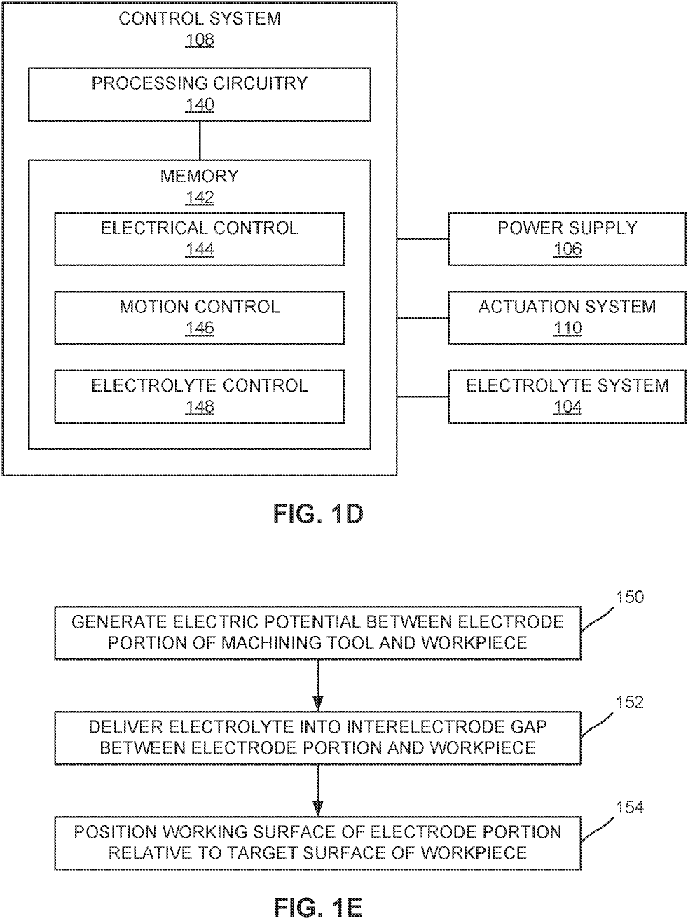

Machining tools described herein may be used as part of a pulsed electrochemical machining (pECM) system. FIG. 1A is a schematic conceptual block diagram illustrating an example pECM system 100 for machining a workpiece 120. pECM system 100 includes a mechanical system 102, an electrolyte system 104, a power supply 106, and a control system 108. While illustrated as separate components, the various components of pECM system 100 may be integrated with other components (e.g., power supply 106 incorporated into mechanical system 102) or overlap with other components (e.g., controllers of mechanical system 102 overlapping with control system 108). While examples of the disclosure are described primarily with regard to pulsed electrochemical machining processes performed by pECM system 100, other examples of the disclosure may be employed using other machining techniques that employ electrochemical machining to shape or otherwise selectively remove material from a workpiece.

Mechanical system 102 may include an actuation system 110, a machining tool 112, and an enclosure system 114. Actuation system 110 may be configured to control a position of machining tool 112 relative to workpiece 120. During a pECM process, actuation system 110 may adjust the position of tool 112 relative to workpiece 120 as needed by moving tool 112, workpiece 120, or both. Actuation system 110 may include one or more actuators, such as direct drive actuators, configured to move tool 112 and/or workpiece 120 as desired during a pECM process. For examples, one or more actuators may be configured to feed or otherwise move machining tool 112 toward workpiece 120 during a pECM process. In some examples, actuation system 110 may be configured to oscillate machining tool 112 (e.g., along the z-axis shown in FIGS. 1B and 1C). Such movement of tool 112 by actuation system may improve removal of dissolved material and restore a concentration of electrolyte between machining tool 112 and workpiece 120. As illustrated in the example of FIG. 1A, mechanical system 102 may be configured to receive electrolyte from electrolyte system 104 and discharge the electrolyte to or proximate to machining tool 112.

Machining tool 112 may be configured to mechanically couple to actuation system 110 and electrically couple to power supply 106. For example, machining tool 112 may include one or more structures or assemblies to couple to actuation system 110, such that machining tool 112 receives a control force for positioning machining tool 112, electrolyte (if distributed via mechanical system 102) for discharging from machining tool 112, and electrical current for generating an electric potential between machining tool 112 and workpiece 120. As will be described further in FIGS. 1B and 1C below, machining tool 112 may be configured to define a working surface that, in combination with workpiece 120 and the electrolyte supplied by electrolyte system 104, forms an electrolytic cell that dissolves material from the outer surface of workpiece 120 using electrolysis.

Enclosure system 114 may be configured to mount workpiece 120 and electrically couple workpiece 120 to power supply 106 for generating a voltage between machining tool 112 and workpiece 120 (e.g., in the form of a pulsed direct current). For example, enclosure system 114 may position workpiece 120 toward machining tool 112, such that a working surface of workpiece 120 is exposed to a working surface of machining tool 112. In some examples, enclosure system 114 may capture spent electrolyte from workpiece 120 for return to electrolyte system 104.

Electrolyte system 104 may be configured to condition and circulate electrolyte (e.g., liquid electrolyte) for distribution to a working surface of machining tool 112, such as via mechanical system 102. Electrolyte system 104 may include one or more pumps configured to discharge the electrolyte to mechanical system 102, one or more filters configured to filter contaminants from the electrolyte (e.g., for the re-use of electrolyte in the pECM process), one or more heat exchangers configured to remove heat from the electrolyte, and/or other components configured to maintain various parameters of the electrolyte.

Power supply 106 may be configured to generate an electric potential between machining tool 112 and workpiece 120. For example, power supply 106 may be configured to apply a voltage between machining tool 112 and workpiece 120 to generate current flow between machining tool 112 and workpiece 120 with the electrolyte flowing or otherwise present between machining tool 112 and workpiece 120. For a pulse EMC process, power supply 106 may be configured to supply voltage in pulses, such as in combination with oscillations of machining tool 112 relative workpiece 120, to increase local current density. For example, power supply 106 may include a direct current (DC) source that applies a pulsed direct current to both machining tool 112 and workpiece 120 during the pulse electrochemical machining process. In some examples, actuation system 110 may oscillate the position of machining tool 112 relative workpiece 120 in coordination with the pulsed direct current.

Control system 108 may be communicatively coupled to mechanical system 102, electrolyte system 104, and power supply 106, and configured to send control signals to mechanical system 102, electrolyte system 104, and power supply 106. For example, the control signals may cause mechanical system 102 to control (e.g., dynamically) a position of machining tool 112 relative to workpiece 120, cause electrolyte system 104 to supply electrolyte between machining tool 112 and workpiece 120, and cause power supply 106 to generate an electric potential between machining tool 112 and workpiece 120. Further operation of control system 108 will be described in FIG. 1D below.

Machining tool 112 defines a working surface that forms workpiece 120 into a component having a particular shape or set of dimensions (e.g., approximately the complimentary shape of machining tool 112). FIG. 1B is a side view cross-sectional conceptual diagram illustrating operation of machining tool 112 of pECM system 100 of FIG. 1A. Machining tool 112 includes a tool body 116 defining a tool axis that aligns with an axis of actuation system 110 of FIG. 1A. Tool body 116 includes one or more electrodes 122 (one or more cathodes). While illustrated in FIG. 1B as including a single electrode 122, tool body 116 may include multiple electrodes 122. While the term electrode is used herein for the machining tool, an electrode generally defines a cathode during a pECM process and may be referred to as such. However, in some cases, a pECM process may include reversing the polarity of a pulse such that the tool electrode functions (e.g., periodically) as the anode with the workpiece being the cathode.

Each electrode 122 defines a working surface 124 at a distal end of the tool axis. When machining tool 112 is attached to actuation system 110, each working surface 124 is configured to face a corresponding target surface 126 of workpiece 120. In some examples, such as illustrated in FIG. 1B, tool body 116 may include an electrolyte channel 118 configured to receive an electrolyte from electrolyte system 104 (e.g., via mechanical system 102) and discharge the electrolyte through one or more openings near working surface 124 of electrode 122.

Each electrode 122 includes an electrically conductive material at working surface 124. An electrically conductive material may include any material having an electrical conductivity greater than about 1 × 10⁶ S/m. Likewise, workpiece 120 may be an electrically conductive material. The electrically conductive material of electrode 122 may include a coating on a support substrate, such as having a thickness greater than about 100 nanometers, or may include a bulk material that is self-supporting. When an electric potential (e.g., in the form of a pulse direct current) is generated between working surface 124 of electrode 122 and target surface 126 of workpiece 120 (e.g., with power supply under the control of control system 108), working surface 124 may form a cathode surface and target surface 126 may form an anode surface. As working surface 124 is advanced and material from workpiece 120 is removed, a shape of target surface 126 may generally correspond to the complimentary shape of working surface 124. While the shape of workpiece 120 is shown to mirror the shape of electrode 122 in FIG. 1B, in other examples, the dimensions and shape formed in workpiece 120 from the removal of material from workpiece 120 do not exactly mirror the shape of the tool 112.

The conductive materials of electrode(s) 122 and workpiece 120 may be any suitable conductive material such as metal, metal alloy, or ceramic material. Examples of metals that may be used to form the workpiece 120 and the electrode(s) 122 of tool 112 include nickel, iron, and titanium-based alloys in a variety of formats such as cast (including single crystal), forged, additively manufactured, and powdered metallurgy. Examples of suitable metals and metal alloys for the workpiece 120 and electrode(s) 122 of tool 112 include, but are not limited to, any superalloy such as CMSX-4, MarM247, Haynes 230, Rene N-5, MP35N, and the like, steels such as 4140, A2 tool steel, M4 tool steel, and gear steels such as Ferrium C64, Al 6061, Al 7075, brass, bronze, CoCr, Cu, Ge, Inconels such as 625, 718, and 740h, Mo, Ni, Nitinol, Nitronic 60, Pyrowear 53, stainless steels such as 17-4, 304, 316, and 440C, Ti Grade 1-5, Ti 64, TiAl, and mixtures and combinations thereof.

pECM system 100 may be particularly suited for machining relatively hard superalloys as workpiece 120, including nickel superalloys such as CMSX-4. In some examples, the nickel superalloy may have a composition including Chromium (e.g., about 5.5 wt% to about 7.5 wt%), Cobalt (e.g., about 9 wt% to about 11 wt%), Molybdenum (e.g., about 0.3 wt% to about 0.9 wt%), Tungsten (e.g., about 5 wt% to about 7 wt%)e.g., with the balance being nickel. In some examples, such a nickel superalloy may also include Titanium (e.g., about 0.5 wt% to about 1.5 wt%), Titanium (e.g., about 0.5 wt% to about 1.5 wt%), Hafnium (e.g., about 0 wt% to about 0.2 wt%), Tantalum (e.g., about 5.5 wt% to about 6.5 wt%), Tantalum (e.g., about 5.5 wt% to about 6.5 wt%), Rhenium (e.g., about 2 wt% to about 4 wt%), and/or Rhenium (e.g., about 2 wt% to about 4 wt%) in trace amounts.

FIG. 1C is a side view cross-sectional conceptual diagram showing a magnified view within window 121 indicated in FIG. 1B to illustrate operating principles of the pECM tool of FIG. 1B. Working surface 124 of electrode 122 is positioned relative to target surface 126 of workpiece 120 to form an interelectrode gap 130, and an electrolyte 132 flows through interelectrode gap 130. When an electric potential (e.g., in the form of a pulse direct current) is generated between working surface 124 and target surface 126, current flows from working surface 124 to target surface 126 via electrolyte 132 to form an electrolytic cell. The current dissolves material at target surface 126 to generate electrochemical reaction products that include dissolved material 134, hydrogen gas 136, and heat. Electrolyte 132 carries away the electrochemical reaction products from interelectrode gap 130. In general, material removal rate may be related to current density in interelectrode gap 130. The current density in interelectrode gap 130 may be related to a variety of parameters including, but not limited to: spatial parameters, such as a distance of interelectrode gap 130; electrical parameters, such as an electric potential across interelectrode gap 130; electrolyte parameters, such as a flow rate of electrolyte 132; and other parameters that may affect flow of current from working surface 124 to target surface 126.

In some examples, working surface 124 may have an electrical conductivity that varies spatially across working surface 124. For example, an electrically conductive material of a surface portion of electrode 122 near working surface 124 may have an electrical conductivity that is higher at particular portions of working surface 124. The electrical conductivity of working surface 124 may generate a local current density at interelectrode gap 130. As a result, portions of working surface 124 that have a higher current density between interelectrode gap 130 may have an increased rate of material removal and/or an increased thickness of interelectrode gap 130. As such, both a contour and shape of working surface 124 and an electrical conductivity of working surface 124 may be configured to generate a contour and shape of target surface 126 of workpiece 120.

FIG. 1D is a conceptual block diagram illustrating an example control system 108 of pECM system 100 of FIG. 1A. Control system 108 includes processing circuitry 140 and a memory 142. Memory 142 includes computer-readable instructions that, when executed by processing circuitry 140, causes processing circuitry 140 to perform various functions related to control of components of pECM system 100. Processing circuitry 140 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to processing circuitry 140 herein may be embodied as software, firmware, hardware or any combination thereof. Memory 142 may include any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Memory 142 may store any suitable information, including information for executing one or more electrochemical machining processes with which pECM system 100 performs on workpiece 120. For example, memory 142 may store one or more of electrical control instructions 144, motion control instructions 146, and electrolyte control instruction 148 in separate memories within memory 142 or separate areas within memory 142. Electrical control 144, motion control 146, and electrolyte control 148 may, in combination, define parameters that control pECM system 100 to remove material from workpiece 120 to generate a component having particular dimensions. In some examples, workpiece 120 may be a partially fabricated component having relatively rough dimensions, such that the pECM process may further refine workpiece 120 to relatively fine dimensions.

Electrical control 144 may define values for electrical parameters of a pECM process including, but not limited to, voltage amplitude applied to electrode 122 and workpiece 120, frequency of electric current, duty cycle (e.g., pulse length), current amplitude, and other electric parameters associated with control of current across interelectrode gap 130. Processing circuitry 140 may generate and send control signals that include the electrical parameters to electrical control circuitry of power supply 106.

Motion control 146 may define values for motion parameters of a pECM process including, but not limited to, feed rate of machining tool 112, position of machining tool 112 (e.g., depth limit of machining tool 112), frequency of oscillation of machining tool 112, amplitude of oscillation of machining tool 112, length of interelectrode gap 130, and other motion parameters associated with control of relative and/or time-varying position of working surface 124. Processing circuitry 140 may generate and send control signals that include the motion parameters to actuation circuitry of actuation system 110.

Electrolyte control 148 may define values for electrolyte parameters of a pECM process including, but not limited to, flow rate of electrolyte 132 through interelectrode gap 130, temperature of electrolyte 132, and other electrolyte parameters associated with conditions of electrolyte 132 in interelectrode gap 130. Processing circuitry 140 may generate and send control signals that include the electrolyte parameters to electrolyte control circuitry of electrolyte system 104.

FIG. 1E is a flow diagram illustrating an example technique for controlling pECM system 100 of FIG. 1A. While illustrated sequentially, the various steps of FIG. 1E may be initiated in a different order (or sequentially) to remove material from workpiece 120. Control system 108 may cause power supply 106 to generate an electric potential between electrode 122 and workpiece 120 (150) and cause electrolyte system 104 to deliver electrolyte 132 into interelectrode gap 130 between working surface 124 of electrode 122 and target surface 126 of workpiece 120 (152) to form an electrolytic cell. Control system 108 may cause actuation system 110 to position working surface 124 of electrode 122 relative to target surface 126 of workpiece 120 (154) to control the size of interelectrode gap 130 and advance working surface 124 toward target surface 126 as material is removed from workpiece 120. In some examples, interelectrode gap 130 may be on the order of about 10 microns although other values are contemplated.

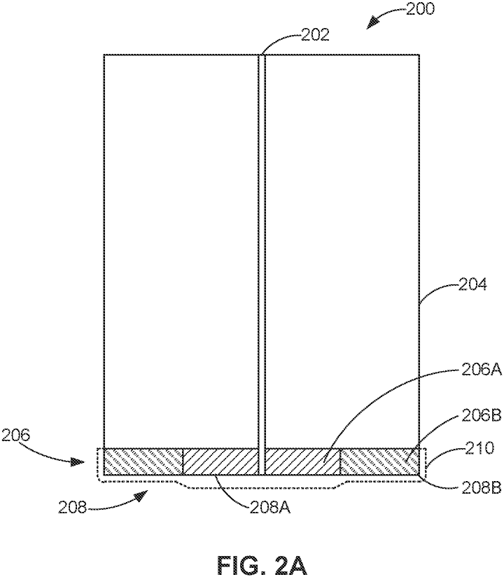

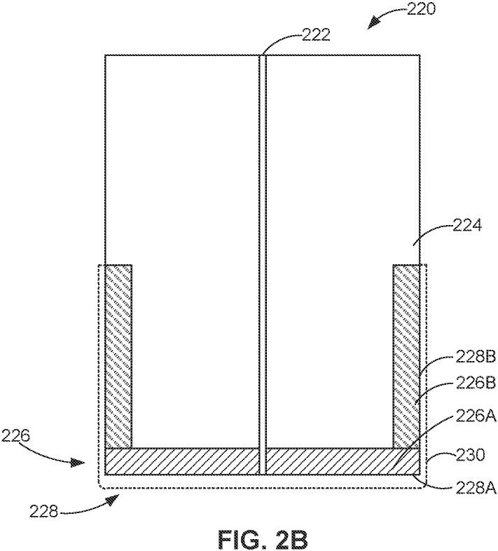

As mentioned above, pECM tools described herein may include one or more electrically conductive materials that produce an electric potential at a working surface of an electrode that varies across the working surface. In some examples, such as will be described in FIGS. 2A and 2B below, pECM tools may include one or more discrete portions of different electrically conductive materials having different electrical conductivities to define a working surface having an electrical conductivity that varies spatially across the working surface.

In some examples, an electrode of a pECM tool may include a working surface at a leading end of the electrode that include a spatially varying electrical conductivity. For example, a finished target surface of a workpiece may include various features and contours that may be difficult to form as a direct mirror of a working surface of an electrode, and that may be aided by decoupling the contour of the target surface of the workpiece from the contour of the working surface of the electrode. FIG. 2A is a side view cross-sectional conceptual diagram illustrating a tool body 200 of a pECM tool. Tool body 200 includes a support substrate 204 and an electrode 206 at a distal end of support substrate 204 defining a working surface 208. Electrode 206 includes two discrete portions 206A and 206B. However, in other example pECM tools, electrodes may include more than two discrete electrode portions 206, and may be arranged in any pattern or configuration corresponding to a desired shape of working surface 208.

Each portion of electrode 206 includes an electrically conductive material having a particular bulk electrical conductivity and defines a portion of working surface 208 configured to interface with a workpiece. Different portions of electrode 206 include different materials have different bulk electrical conductivities, such that electrode 208 may have an electrical conductivity that varies across working surface 208 of electrode 206 according to the particular portion of electrode 206 forming the particular portion of working surface 208. As an illustration of variation in electrical conductivity, FIG. 2A illustrates an example current density distribution 210 defined by electrode 206 for a substantially uniform electrically conductive electrolyte, in which a magnitude of local current density corresponds to the electrical conductivity at the particular portion of working surface 208.

In the example of FIG. 2A, electrode 206 includes a first electrode portion 206A that is radially inward (e.g., furthest from an edge) and a second electrode portion 206B that is radially outward (e.g., closest to an edge). First electrode portion 206A defines a first working surface portion 208A and includes a first electrically conductive material that has a first electrical conductivity. Second electrode portion 206B defines a second working surface portion 208B and includes a second electrically conductive material that has a second electrical conductivity. The second conductivity is less than the first electrical conductivity, such that a current density may be higher near first working surface portion 208A than second working surface portion 208B, as illustrated by the shape of current density distribution 210.

During material removal from a workpiece, electrode 206 may form a thicker interelectrode gap near first working surface portion 208A than near second working surface portion 208B, resulting in a target surface of the workpiece that corresponds to both a shape of working surface 208 and a spatial variation of electrical conductivity at working surface 208. As a result of this decoupling of the contour of working surface 208 and the current density distribution across working surface 208, tool body 200 may be relatively simple to manufacture, as a working surface 208 may have a planar shape, yet still generate a nonplanar target surface on a workpiece. As another example, working surface 208 may be contoured for other considerations, such as flow of electrolyte, while still forming a desired contour of a target surface of a workpiece.

In some examples, an electrode of a pECM tool may include a spatially varying working surface at a leading end of an electrode and one or more lateral surfaces of the electrode. For example, for a particular tool path, an electrode may be capable of both removing material from portions of a workpiece along an axis of the tool body and removing material from portions of a workpiece parallel to the axis of the tool body. FIG. 2B is a side view cross-sectional conceptual diagram illustrating a tool body 220 of a pECM too. Tool body 220 includes an electrolyte channel 222, a support substrate 224, and an electrode 226 at a distal end and lateral side of support substrate 224 defining a working surface 228, such as described in FIG. 2A. Support substrate 224 may include any substantially rigid, supportive material, such as stainless steel, copper, brass, polymers, and the like. Electrode 226 includes two discrete portions 226A and 226B. However, in other example pECM tools, electrodes may include more than two discrete electrode portions 226, and may be arranged in any pattern or configuration corresponding to a desired shape of working surface 228.

Like electrode 206 of FIG. 2A, each portion of electrode 226 includes an electrically conductive material having a particular bulk electrical conductivity and defines a portion of working surface 228 configured to face a workpiece. Different portions of electrode 226 include different materials have different bulk electrical conductivities, such that electrode 226 may have an electrical conductivity that varies across the different portions of working surface 228 of electrode 226. As an illustration of variation in electrical conductivity, FIG. 2B illustrates an example current density distribution 230 defined by electrode 226 for a substantially uniform electrically conductive electrolyte, in which a magnitude of local current density corresponds to the electrical conductivity at the particular portion of working surface 228.

In the example of FIG. 2B, electrode 226 includes a first electrode portion 226A at a distal end of tool body 220 and a second electrode portion 226B that runs along lateral sides of tool body 220. First electrode portion 226A defines a distal working surface portion 228A and includes a first electrically conductive material that has a first electrical conductivity. Second electrode portion 226B defines a lateral working surface portion 228B and includes a second electrically conductive material that has a second electrical conductivity that is different than the first electrical conductivity. In the example of FIG. 2B, the second electrical conductivity is less than the first electrical conductivity, and as a result, a current density may be higher near distal working surface portion 228A than lateral working surface portion 228B, as illustrated by the shape of current density distribution 230.

During material removal, electrode 226 may remove material from a workpiece at a higher rate near distal working surface portion 228A than near lateral working surface portion 228B. For example, distal working surface portion 228A may remove material from a workpiece along the axis of tool body to create a cavity within the workpiece, while lateral working surface portion 228B may continue to remove material from the workpiece along sides of the cavity in the workpiece. The material removal requirements for these different surfaces of the workpiece may be different, such that the electrical conductivities of first electrode portion 226A and second electrode portion 226B may be different to account for such desired variation in material removal from the workpiece.

Electrodes of pECM tools described herein, such as electrodes 206 and 226 of FIGS. 2A and 2B, may have a variety of electrical conductivities. In some examples, a portion of an electrode, such as first electrode portions 206A and 226A, may have a relatively high electrical conductivity, while another portion of the electrode, such as second electrode portions 206B and 226B, may have a relatively low electrical conductivity, such as at least 10% lower electrical conductivity than the relatively high electrical conductivity. For example, a high electrical conductivity material, such as copper or aluminum, may have an electrical conductivity greater than about 20 S/m, while a medium electrical conductivity material, such as stainless steel, may have an electrical conductivity between about 1 S/m and about 20 S/m. In some examples, an electrode includes at least one electrode portion having a high electrical conductivity material and at least one electrode portions having a medium electrical conductivity material.

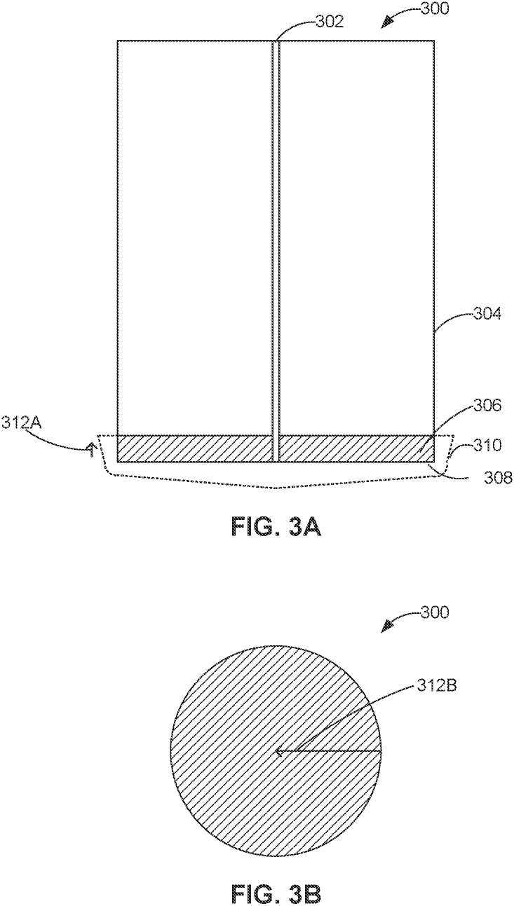

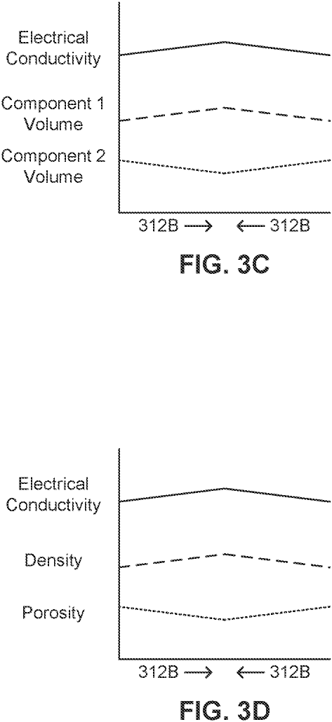

In some examples, rather than or in addition to using discrete portions of different electrically conductive materials, electrodes may include a spatially varying composition of one or more electrically conductive materials, such as an alloy or porous material, such that a working surface of the electrode may have a gradient of electrical conductivity. FIG. 3A is a side view cross-sectional conceptual diagram illustrating a tool body 300 of a pECM tool that includes a distal portion having one or more gradients of electrical conductivity in one or more directions, while FIG. 3B is a bottom view conceptual diagram illustrating tool body 300 of FIG. 3A. Tool body 300 includes an electrolyte channel 302, a support substrate 304, and an electrode 306 at a distal end of support substrate 304 defining a working surface 308, such as described in FIGS. 2A and 2B. Electrode 306 includes one or more electrically conductive materials having a combination or density that results in a particular bulk electrical conductivity and defines a portion of working surface 308 configured to face a workpiece. Different portions of electrode 306 include different combinations or densities that result in different bulk electrical conductivities, such that electrode 306 may have one or more gradients of electrical conductivity that vary across working surface 308 of electrode 306. As an illustration of variation in electrical conductivity, FIG. 3A illustrates an example current density distribution 310 defined by electrode 306, in which a magnitude of current density corresponds to the electrical conductivity at the particular portion of working surface 308.

In the example of FIGS. 3A and 3B, electrode 306 includes an axial gradient of electrical conductivity 312A that increases away from a distal end and a radial gradient of electrical conductivity 312B that increases toward a radial center of electrode 306. As a result, a current density may be higher near areas of higher electrical conductivity, as illustrated by the shape of current density distribution 310. During material removal, electrode 306 may form an interelectrode gap that corresponds to the various gradients of electrical conductivity 312A and 312B.

In some examples, a composition of electrode varies across working surface 308. FIG. 3C is an exemplary graph illustrating a relationship between radial gradient of electrical conductivity 312B of FIG. 3B and a volume ratio of two constituent components having different electrical conductivities. Electrode 306 may have a composition that includes an alloy having two or more components having different electrical conductivities. In the example of FIG. 3C, the alloy includes a first component having a first electrical conductivity and a second component having a second electrical conductivity, less than the first electrical conductivity. A volume ratio of the first and second components varies across the working surface. For example, a volume fraction of the first component may increase toward the center of electrode 306 and a volume fraction of the second component may decrease toward the center of electrode 306, such that a bulk electrical conductivity may increase toward the center of electrode 306. In some examples, the alloy may include a conductive component and a non-conductive component. For example, the conductive component may be selected for electrical properties, such as electrical conductivity, while the non-conductive component may be selected for other properties that support the first component, such as manufacturability, mechanical properties, non-interference with electrical properties, and the like.

In some examples, rather than or in addition to varying a material composition of electrode 306 across working surface 308, at least one of a density or a porosity of electrode 306 varies across working surface 308. FIG. 3D is an exemplary graph illustrating a relationship between a radial gradient of electrical conductivity 312B and a density and porosity of a component. In the example of FIG. 3D, as a porosity of electrode 306 decreased along radial gradient 312B, a density of the electrically conductive material, and therefore an electrical conductivity of electrode 306, increases. By controlling porosity and/or density of the electrically conductive material, a particular current density distribution may be produced.

In the example of FIGS. 3A and 3B, the resulting current density distribution may decrease according to a distance from a center of electrode 306. However, any pattern or shape of current density distribution 310 may be produced by the varying a composition, density, and/or porosity of electrically conductive material or materials in electrode 306. In some examples, a gradient of electrical conductivity across working surface 308 may be configured to form a particular contour on a target surface of a workpiece. For example, a contour of current density distribution 310 may be shaped to a relatively high resolution matching the desired contour of the target surface of the workpiece. In some examples, a gradient of electrical conductivity across working surface 308 may be configured to reduce process irregularities that may form during manufacturing. For example, as an electrolyte travels along an interelectrode gap, a conductivity of the electrolyte may decrease due to depletion of the electrolyte and/or accumulation of workpiece material. A spatial distribution of electrical conductivity across working surface 308 may have increased electrical conductivity at portions of reduced electrolyte conductivity, thereby creating a relatively even current density distribution.

Electrodes of pECM tools described herein, such as electrode 306 of FIGS. 3A and 3B, may have a variety of gradients of electrical conductivities, porosities, and densities. In some examples, electrodes include a gradient of electrical conductivity, porosity, or density that varies at least 10% across the working surface of the electrode. In some examples, a porosity of at least a portion of the electrode is greater than about 0.05, a density of at least a portion of the electrode is less than about 95% of the solid electrically conductive material. In some examples in which the electrically conductive material of the electrode is an alloy, a difference in electrical conductivity between two or more components of the electrically conductive material is at least 10% and/or at least 10 × 10⁶ S/m.

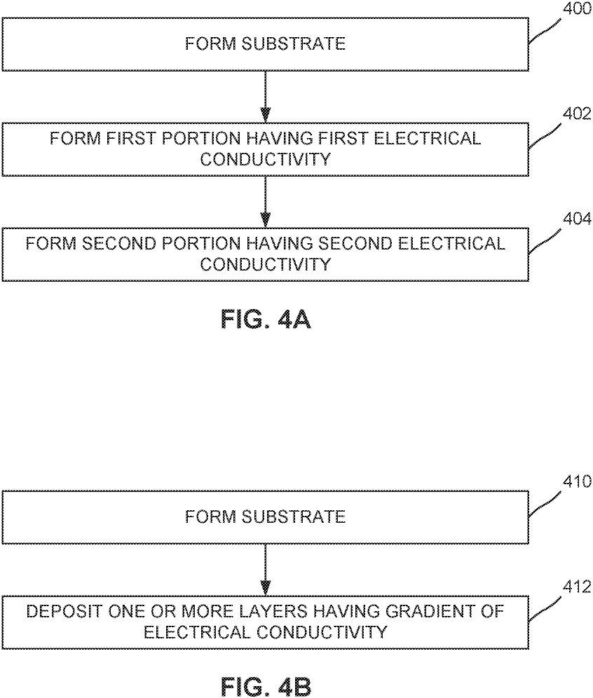

pECM tools described herein may be manufactured using a variety of processes to form a spatially varying electrical conductivity across a working surface of an electrode of the pECM tool. FIG. 4A is a flow diagram illustrating an example process for manufacturing a pECM tool that includes discrete portions of a working surface having different electrical conductivities. The process of FIG. 4A will be described with reference to tool body 220 of FIG. 2B; however, other tool bodies may be manufactured by the process of FIG. 4A.

The example of FIG. 4A may include forming a substrate (400), such as substrate 224, as well as any support structures within substrate 224, such as electrolyte channel 222 and any electrical connections. In some examples, one or more surfaces of substrate 224 may correspond to a working surface of an electrode, such as working surface 228 of electrode 226. For example, substrate 224 may be manufactured from a material that is relatively easy to form, such as through additive or subtractive manufacturing, compared to an electrically conductive material of electrode 226.

The example process of FIG. 4A includes forming a first portion 226A of an electrically conductive material on substrate 224 having a first electrical conductivity (402) and a second portion 226B of an electrically conductive material on substrate 224 having a second electrical conductivity (404). While illustrated as separate steps and in a particular order, forming first portion 226A and second portion 226B may be performed in another order or simultaneously. In some examples, first and second portions 226A and 226B may be independently formed, such as through casting, and assembled on substrate 224, such as with an adhesive or fastener. In other examples, first and second portions 226A and 226B may be formed directly on substrate 224, such as through deposition. First portion 226A and second portion 226B may be formed using any suitable method including, but not limited to, chemical vapor deposition, electrolytic deposition, casting, and the like. A variety of electrically conductive materials may be used for electrode 206 including, but not limited to, of stainless steel, titanium, aluminum, copper, brass, graphite, and the like.

FIG. 4B is a flow diagram illustrating an example process for manufacturing a pECM tool that includes a working surface having a gradient of electrical conductivity. The process of FIG. 4B will be described with reference to tool body 300 of FIGS. 3A and 3B; however, other tool bodies may be manufactured by the process of FIG. 4B. The process of FIG. 4B may include forming a substrate (410), such as substrate 304, such as described in step 400 of FIG. 4A.

The process of FIG. 4B may include depositing one or more layers of an electrically conductive material on a substrate 304 of tool body 300 to form electrode 306 (412). In some examples, the one or more layers of electrode 306 may be deposited using additive manufacturing. For example, additive manufacturing may permit a relatively high level of spatial control of material deposition, such as a particular blend of two or more materials, a particular density of a material, and/or a particular porosity of a material, such that a resulting electrode 306 may have working surface 308 having a spatially varying electrical conductivity.

In some examples, the process of FIG. 4B may include depositing an alloy having two or more components having different electrical conductivities. For example, the alloy may include a first component having a first electrical conductivity and a second component having a second electrical conductivity. An additive manufacturing system may control a flow rate of the first and second components, such that a volume ratio of the first and second components varies across the working surface according to a desired current density distribution. In some examples, the process of FIG. 4B may include depositing an electrically conductive material at a variable density or porosity. For example, an additive manufacturing system may control a flow rate and/or deposition path velocity of an electrically conductive material, such that at least one of a density or a porosity of the at least one electrode varies across working surface 308 according to a desired current density distribution. In some examples, the process of FIG. 4B may include a combination of varying a composition of two or more components of electrode 306 and varying a density or porosity of the two or more components of electrode 306.

In this respect, various aspects of the techniques may enable the following examples.

Example 1: A pulsed electrochemical machining (pECM) tool includes a tool body defining a tool axis, the tool body comprising an electrode, wherein the electrode comprises an electrically conductive material and defines a working surface configured to face a workpiece, and wherein an electrical conductivity of the electrode varies across the working surface of the electrode.

Example 2: The pECM tool of example 1, wherein a composition of the electrode varies across the working surface.

Example 3: The pECM tool of example 2, wherein the composition comprises an alloy having two or more components having different electrical conductivities.

Example 4: The pECM tool of example 3, wherein the alloy comprises a first component having a first electrical conductivity and a second component having a second electrical conductivity, and wherein a volume ratio of the first and second components varies across the working surface.

Example 5: The pECM tool of any of examples 3 and 4, wherein the alloy comprises a conductive component and a non-conductive component.

Example 6: The pECM tool of any of examples 1 through 5, wherein at least one of a density or a porosity of the electrode varies across the working surface.

Example 7: The pECM tool of any of examples 1 through 6, wherein the electrode comprises at least one of stainless steel, titanium, aluminum, copper, brass, or graphite.

Example 8: The pECM tool of any of examples 1 through 7, wherein the working surface of the electrode defines a distal surface, and wherein the distal surface comprises a first portion having a first electrical conductivity and a second portion having a second electrical conductivity, different from the first electrical conductivity.

Example 9: The pECM tool of any of examples 1 through 8, wherein the working surface of the electrode defines a distal surface and one or more lateral surfaces, and wherein the distal surface has a first electrical conductivity and the one or more lateral surfaces have a second electrical conductivity, different from the first electrical conductivity.

Example 10: The pECM tool of any of examples 1 through 9, wherein the electrode comprises a first electrode, and wherein the tool body further comprises a second electrode.

Example 11: A pulsed electrochemical machining (pECM) system includes a pECM tool comprising a tool body defining a tool axis, the tool body comprising an electrode, wherein the electrode comprises an electrically conductive material and defines a working surface configured to face a workpiece; a mechanical system configured to position the working surface of the electrode relative to the workpiece; an electrolyte system configured to supply electrolyte to the mechanical system for delivery to an interelectrode gap between the working surface of the electrode and a target surface of the workpiece; and a power supply configured to generate an electric potential between the electrode of the pECM tool and the workpiece, wherein an electrical conductivity of the electrode varies across the working surface of the electrode.

Example 12: The pECM system of example 11, wherein the pECM tool is configured to generate the interelectrode gap having a variation in thickness.

Example 13: The pECM system of any of examples 11 and 12, wherein a composition of the electrode varies across the working surface.

Example 14: The pECM system of example 13, wherein the composition comprises an alloy having two or more components having different electrical conductivities.

Example 15: The pECM system of example 14, wherein the alloy comprises a first component having a first electrical conductivity and a second component having a second electrical conductivity, and wherein a volume ratio of the first and second components varies across the working surface.

Example 16: The pECM system of any of examples 14 and 15, wherein the alloy comprises a conductive component and a non-conductive component.

Example 17: The pECM system of any of examples 11 through 16, wherein at least one of a density or a porosity of the electrode varies across the working surface.

Example 18: The pECM system of any of examples 11 through 17, wherein the electrode comprises at least one of stainless steel, titanium, aluminum, copper, brass, or graphite.

Example 19: The pECM system of any of examples 11 through 18, wherein the working surface of the electrode defines a distal surface, and wherein the distal surface comprises a first portion having a first electrical conductivity and a second portion having a second electrical conductivity, different from the first electrical conductivity.

Example 20: The pECM system of any of examples 11 through 19, wherein the working surface of the electrode defines a distal surface and one or more lateral surfaces, and wherein the distal surface has a first electrical conductivity and the one or more lateral surfaces have a second electrical conductivity, different from the first electrical conductivity.

Example 21: The pECM system of any of examples 11 through 20, wherein the electrode comprises a first electrode, and wherein the tool body further comprises a second electrode.

Example 22: A method for manufacturing a pulsed electrochemical machining (pECM) tool includes forming an electrode from an electrically conductive material, wherein the electrode defines a working surface of a tool body, the working surface configured to face a workpiece, and wherein an electrical conductivity of the electrode varies across the working surface of the electrode.

Example 23: The method of example 22, wherein forming the electrode further comprises depositing one or more layers of the electrically conductive material on a substrate of the tool body.

Example 24: The method of example 23, wherein the one or more layers are deposited using additive manufacturing.

Example 25: The method of any of examples 22 through 24, wherein a composition of the electrode varies across the working surface.

Example 26: The method of example 25, wherein the composition comprises an alloy having two or more components having different electrical conductivities.

Example 27: The method of example 26, wherein the alloy comprises a first component having a first electrical conductivity and a second component having a second electrical conductivity, and wherein a volume ratio of the first and second components varies across the working surface.

Example 28: The method of any of examples 26 and 27, wherein the alloy comprises a conductive component and a non-conductive component.

Example 29: The method of any of examples 22 through 28, wherein at least one of a density or a porosity of the electrode varies across the working surface.

Example 30: The method of any of examples 22 through 29, wherein the electrically conductive material comprises at least one of stainless steel, titanium, aluminum, copper, brass, or graphite.

Example 31: The method of any of examples 22 through 30, wherein the working surface of the electrode defines a distal surface, and wherein the distal surface comprises a first portion having a first electrical conductivity and a second portion having a second electrical conductivity, different from the first electrical conductivity.

Example 32: The method of any of examples 22 through 31, wherein the working surface of the electrode defines a distal surface and one or more lateral surfaces, and wherein the distal surface has a first electrical conductivity and the one or more lateral surfaces have a second electrical conductivity, different from the first electrical conductivity.

Example 33: The method of any of examples 22 through 32, wherein the electrode comprises a first electrode, and wherein the method further comprises forming a second electrode from an electrically conductive material.

Example 34: A method for pulsed electrochemical machining (pECM) a workpiece includes generating an electric potential between an electrode of the pECM tool of any of examples 1 to 10 and the workpiece; delivering an electrolyte into an interelectrode gap between the working surface of the electrode and a target surface of the workpiece; and positioning the working surface of the electrode relative to the target surface of the workpiece to remove material from the target surface of the workpiece.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A pulsed electrochemical machining (pECM) tool, comprising:
a tool body defining a tool axis, the tool body comprising an electrode,
wherein the electrode comprises an electrically conductive material and defines a working surface configured to face a workpiece, and
wherein an electrical conductivity of the electrode varies across the working surface of the electrode.

2. The pECM tool of claim 1, wherein a composition of the electrode varies across the working surface.

3. The pECM tool of claim 2, wherein the composition comprises an alloy having two or more components having different electrical conductivities.

4. The pECM tool of claim 3,
wherein the alloy comprises a first component having a first electrical conductivity and a second component having a second electrical conductivity, and
wherein a volume ratio of the first and second components varies across the working surface.

5. The pECM tool of claim 3, wherein the alloy comprises a conductive component and a non-conductive component.

6. The pECM tool of claim 1, wherein at least one of a density or a porosity of the electrode varies across the working surface.

7. The pECM tool of claim 1, wherein the electrode comprises at least one of stainless steel, titanium, aluminum, copper, brass, or graphite.

8. The pECM tool of claim 1,
wherein the working surface of the electrode defines a distal surface, and
wherein the distal surface comprises a first portion having a first electrical conductivity and a second portion having a second electrical conductivity, different from the first electrical conductivity.

9. The pECM tool of claim 1,
wherein the working surface of the electrode defines a distal surface and one or more lateral surfaces, and
wherein the distal surface has a first electrical conductivity and the one or more lateral surfaces have a second electrical conductivity, different from the first electrical conductivity.

10. The pECM tool of claim 1,
wherein the electrode comprises a first electrode, and
wherein the tool body further comprises a second electrode.

11. A pulsed electrochemical machining (pECM) system, comprising:
a pECM tool comprising a tool body defining a tool axis, the tool body comprising an electrode, wherein the electrode comprises an electrically conductive material and defines a working surface configured to face a workpiece;
a mechanical system configured to position the working surface of the electrode relative to the workpiece;
an electrolyte system configured to supply electrolyte to the mechanical system for delivery to an interelectrode gap between the working surface of the electrode and a target surface of the workpiece; and
a power supply configured to generate an electric potential between the electrode of the pECM tool and the workpiece,
wherein an electrical conductivity of the electrode varies across the working surface of the electrode.

12. The pECM system of claim 11, wherein the pECM tool is configured to generate the interelectrode gap having a variation in thickness.

13. A method for manufacturing a pulsed electrochemical machining (pECM) tool, comprising:
forming an electrode from an electrically conductive material,
wherein the electrode defines a working surface of a tool body, the working surface configured to face a workpiece, and
wherein an electrical conductivity of the electrode varies across the working surface of the electrode.

14. The method of claim 13, wherein forming the electrode further comprises depositing one or more layers of the electrically conductive material on a substrate of the tool body.

15. The method of claim 13, wherein a composition of the electrode varies across the working surface.

16. The method of claim 15, wherein the composition comprises an alloy having two or more components having different electrical conductivities.

17. The method of claim 16,
wherein the alloy comprises a first component having a first electrical conductivity and a second component having a second electrical conductivity, and
wherein a volume ratio of the first and second components varies across the working surface.

18. The method of claim 13, wherein at least one of a density or a porosity of the electrode varies across the working surface.

19. The method of claim 13,
wherein the working surface of the electrode defines a distal surface, and
wherein the distal surface comprises a first portion having a first electrical conductivity and a second portion having a second electrical conductivity, different from the first electrical conductivity.

20. The method of claim 13,
wherein the working surface of the electrode defines a distal surface and one or more lateral surfaces, and
wherein the distal surface has a first electrical conductivity and the one or more lateral surfaces have a second electrical conductivity, different from the first electrical conductivity.
